(19) United States
(12) Patent Application Publication
(10) Pub. No.: US 2019/0075370 A1
(43) Pub. Date: Mar. 7, 2019

(54) DISPLAY APPARATUS, CONTENT MANAGING APPARATUS, CONTENT MANAGING SYSTEM, AND CONTENT MANAGING METHOD

(71) Applicant: SAMSUNG ELECTRONICS CO., LTD., Suwon-si (KR)

(72) Inventors: Sang-Won KIM, Suwon-si (KR); Young Kook KIM, Seongnam-si (KR)

(73) Assignee: SAMSUNG ELECTRONICS CO., LTD., Suwon-si (KR)

(21) Appl. No.: 16/119,528

(22) Filed: Aug. 31, 2018

(30) Foreign Application Priority Data
Sep. 4, 2017 (KR) 10-2017-0112749

(51) Int. Cl. H04N 21/8358; H04N 21/4223; H04N 21/266; H04N 21/458

(52) U.S. Cl. CPC H04N 21/8358; H04N 21/458; H04N 21/266; H04N 21/4223

(57) ABSTRACT

A display apparatus, a content management apparatus, a content management system, and a content management method for verifying correct reproduction of content are provided. The display apparatus may include: a receiver configured to receive a content image; a display configured to reproduce the content image and display, over the content image being reproduced, a content identification color for identifying the content image; a sensing device mounted on at least one side of the display; and a controller configured to generate reproduction confirmation data for verifying reproduction of the content image based on an output of the sensing device.

### CROSS-REFERENCE TO RELATED APPLICATION

This application is based on and claims priority under 35 U.S.C. § 119 to Korean Patent Application No. 10-2017-0112749, filed on Sep. 4, 2017, in the Korean Intellectual Property Office, the disclosure of which is incorporated herein by reference in its entirety.

### BACKGROUND

### 1. Field

The disclosure relates to a display apparatus, a content management apparatus, a content management system, and a content management method, capable of verifying correct reproduction of content.

### 2. Description of the Related Art

In the related art, there are many different ways to deliver advertisements to potential consumers. For example, an advertisement may be inserted into a broadcast signal, or an advertisement image may be generated through a large-format display (LFD) installed outdoors.

In the former case, advertisement images may be shown between programs on a network or cable television channel, so that the advertisement may be delivered to consumers in any environment where the programs are watched.

In the latter case, advertisement images may be generated through an LFD installed at a place where many people are present, such as a subway station, a movie theater, a bus stop, a shopping mall, and the like, so that the advertisement may be delivered to consumers near the display apparatus.

### SUMMARY

Provided are a display apparatus, a content management apparatus, a content management system, and a content management method, in which each content is assigned a unique color and a content image is displayed to be overlaid with a content identification color that is generated using the content image and the unique color, so that reproduction of the content is checked.

Additional aspects of the disclosure will be set forth in part in the description which follows and, in part, will be obvious from the description, or may be learned by practice of the presented embodiments.

In accordance with an aspect of the present disclosure, a display apparatus may include: a receiver configured to receive a content image; a display configured to reproduce the content image and display, over the content image being reproduced, a content identification color for identifying the content image; a sensing device mounted on at least one side of the display; and a controller configured to generate reproduction confirmation data for verifying reproduction of the content image based on an output of the sensing device.

The sensing device may be configured to sense the content identification color displayed over the content image.

The controller may be further configured to generate the content identification color using a representative pixel value of at least one region of the content image and a unique color assigned to the content image.

The receiver may be further configured to receive the content identification color generated using a unique color assigned to the content image and (ii) the content image.

The controller may be further configured to generate the reproduction confirmation data by comparing the content identification color with the output of the sensing device.

The content identification color may include a plurality of frame content identification colors respectively corresponding to a plurality of image frames included in the content image.

The display is further configured to, while displaying one image frame of the plurality of image frames, may display, over the one image frame, a frame content identification color corresponding to the one image frame.

The controller may be further configured to compare the output of the sensing device with the content identification color at each of the plurality of image frames to determine whether the output of the sensing device matches the content identification color, and the reproduction confirmation data may include a result of the determination whether the output of the sensing device matches the content identification color.

The display apparatus may further include a transmitter configured to transmit the reproduction confirmation data to a content management apparatus.

The display may be further configured to display the content identification color in a predetermined region of the display, and the sensing device may be provided at a position corresponding to the predetermined region in which the content identification color is displayed.

The sensing device may be provided at an edge of the display so as to be projected or retracted.

The receiver may be further configured to receive a time schedule including information about a point of time for reproducing the content image, and the controller may be further configured to compare the content identification color and the time schedule with the output of the sensing device and an output time of the sensing device, respectively, to generate the reproduction confirmation data.

In accordance with an aspect of the present disclosure, a display apparatus may include: a communication interface configured to receive a content image; a display configured to reproduce the content image and display, over the content image being reproduced, a content identification color for identifying the content image; a sensing device mounted on at least one side of the display; and a controller configured to control the communication interface to transmit an output of the sensing device to a content management apparatus.

The sensing device may be configured to sense the content identification color displayed over the content image.

The controller may be further configured to generate the content identification color using a representative pixel value of at least one region of the content image and a unique color assigned to the content image.

The communication interface may be further configured to receive the content identification color generated using a unique color assigned to the content image and the content image.

The content identification color may include a plurality of frame content identification colors respectively corresponding to a plurality of image frames included in in the content image.

The display may be further configured to, while displaying one image frame of the plurality of image frames, display, over the one image frame, a frame content identification color corresponding to the one image frame.

The sensing device may be provided at an edge of the display so as to be projected or retracted.

In accordance with another aspect of the present disclosure, a content management method may include: receiving a content image; reproducing the content image; while the content image is being reproduced, displaying, over the content image being reproduced, a content identification color for identifying the content image; sensing the content identification color displayed over the content image using a sensing device mounted on at least one side of the display; and generating reproduction confirmation data for verifying reproduction of the content image based on a result of sensing the displayed content identification color.

The method may further include receiving the content identification color, which is generated using a unique color assigned to the content image and the content image.

The method may further include generating the content identification image using a representative pixel value of at least one region of the content image and a unique color assigned to the content image.

The generating the reproduction confirmation date may include comparing the output of the sensing device with the content identification color to determine whether the output of the sensing device matches the content identification color.

The generating the content identification color may include generating a plurality of frame content identification colors respectively corresponding to a plurality of image frames included in in the content image.

The displaying the content identification color may include displaying, while displaying one of the plurality of image frames, the content identification color corresponding to the displayed image frame.

### BRIEF DESCRIPTION OF THE DRAWINGS

The above and other aspects, features, and advantages of certain embodiments of the present disclosure will become more apparent from the following description taken in conjunction with the accompanying drawings, in which:

FIGS. 1 and 2 are views schematically illustrating the external appearance of a display apparatus according to an embodiment;

FIG. 3 is a control block diagram illustrating a display apparatus according to an embodiment;

FIG. 4 is a control block diagram illustrating a content management apparatus according to an embodiment;

FIG. 5 is a diagram illustrating an example of unique colors assigned by contents;

FIGS. 6 and 7 are diagrams illustrating examples of extracting information from a content image to generate content identification information;

FIG. 8 is a diagram illustrating an example of information generated by a content management apparatus according to an embodiment;

FIG. 9 is a diagram illustrating an example in which a display apparatus according to an embodiment displays a content identification color;

FIGS. 10 and 11 are views illustrating an example of a sensing device provided in a display apparatus according to an embodiment;

FIG. 12 is a control block diagram illustrating a case when the content management apparatus includes a server and an administrator computer;

FIG. 13 is a view illustrating an example in which a display apparatus and a content management apparatus according to an embodiment are connected to each other via communication;

FIG. 14 is a view illustrating an example in which information is processed and transmitted and received in an administrator computer, a server, and a display apparatus;

FIG. 15 is a view illustrating another example in which information is processed and transmitted and received in an administrator computer, a server, and a display administrator;

FIG. 16 is a view illustrating another example in which information is processed and transmitted and received in an administrator computer, a server, and a display apparatus;

FIG. 17 is a view illustrating another example in which information is processed and transmitted and received in an administrator computer, a server, and a display apparatus;

FIG. 18 is a flowchart showing an example of a content management method according to an embodiment; and

FIG. 19 is a flowchart showing another example of a content management method according to an embodiment.

### DETAILED DESCRIPTION

Hereinafter, the present disclosure will be described in detail with reference to the accompanying drawings.

The embodiments set forth herein and illustrated in the configuration of the present disclosure are examples embodiments and are not representative of the full the technical spirit of the present disclosure, so it should be understood that they may be replaced with various equivalents and modifications at the time of the disclosure.

The terminology used herein is for the purpose of describing example embodiments only and is not intended to be limiting of the disclosure.

As used herein, the singular forms “a,” “an,” and “the” are intended to include the plural forms as well, unless the context clearly indicates otherwise.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Although the terms “first,” “second,” “A,” “B,” etc. may be used to describe various components, the terms do not limit the corresponding components, but are used only for the purpose of distinguishing one component from another component. The terms, such as “part”, “device”, “block”, “member”, “module”, and the like may refer to a unit for processing at least one function or act. For example, the terms may refer to at least process processed by at least one hardware (e.g., field-programmable gate array (FPGA)/application specific integrated circuit (ASIC)), software stored in memories, or processors, or a combination of both hardware and software.

Hereinafter, the embodiments will be described in detail with reference to the accompanying drawings. In the drawings, the same reference numerals may be used to designate the parts and elements performing the same functions throughout the specification.

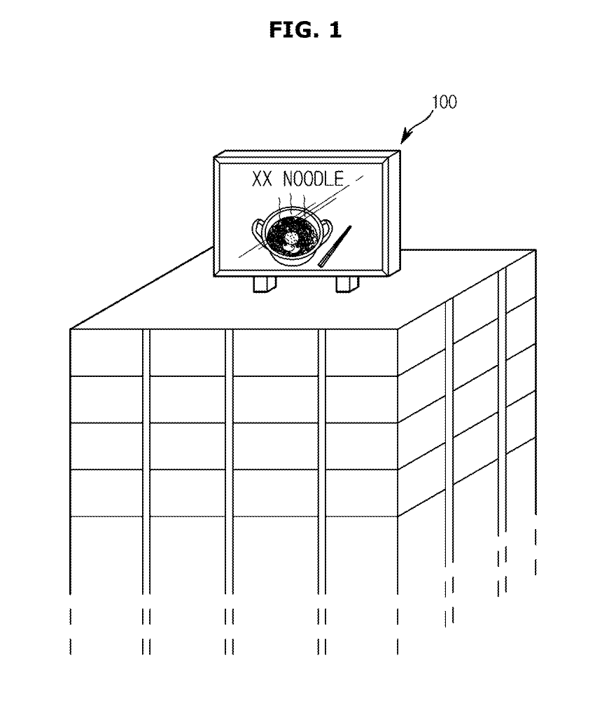

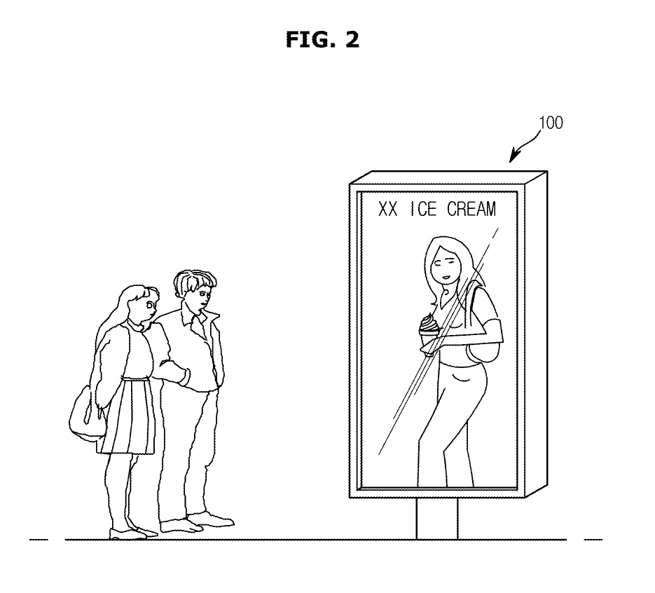

FIGS. 1 and 2 are diagrams schematically illustrating the external appearance of a display apparatus according to an embodiment.

Referring to FIGS. 1 and 2, the display apparatus 100 according to the embodiment may be a large format display (LFD) installed outdoors, such as a rooftop of a building or a bus stop. Here, the outdoor is not limited to an open environment, and the display apparatus 100 may be installed in any place, even indoors, as long as it allows frequent visits of a large number of people, such as a subway station, a shopping mall, a movie theater, a retail store, and the like.

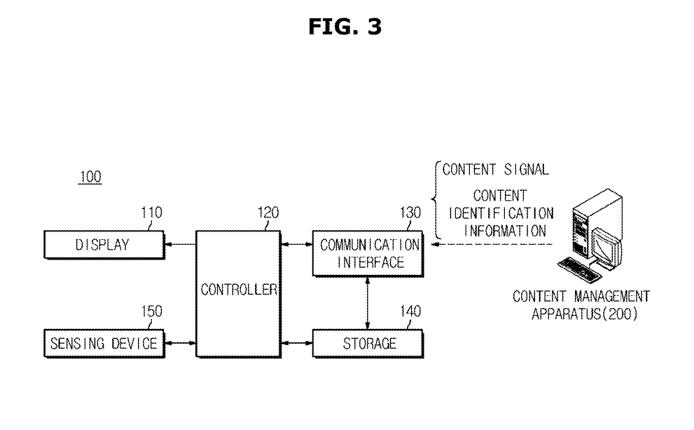

The display apparatus 100 may include a display 110 (see FIG. 3) employing one of various types of display panels, such as a liquid crystal display (LCD) panel, a plasma display panel (PDP), a light emitting diode (LED) display panel, and the like. According to the embodiment, there is no restriction on the type of panels used in the display apparatus 100.

The display apparatus 100 may reproduce (e.g., generate, display, etc.) various content images. For example, an administrator of the display apparatus 100 may reproduce a content image provided by an advertiser through a contract with the advertiser. In this case, the content image provided by the advertiser may be reproduced on a specific display apparatus 100, so there is a need for a method of an advertiser at a remote site to be able to monitor and verify whether the content image is properly reproduced on the display apparatus 100.

The display apparatus 100 according to the embodiment may display a content identification color for identifying a content image to be overlaid on the content image, and sense (e.g., detect) the content identification color, so that it may be checked or verified whether the content image has been properly reproduced. Hereinafter, detailed description is made in relation to a configuration of verifying whether a content image is reproduced.

FIG. 3 is a control block diagram illustrating a display apparatus according to an embodiment.

Referring to FIG. 3, the display apparatus 100 according to the embodiment may include a communication interface 130 that receives content-related information, such as a content signal and content identification information, from a content management apparatus 200, a storage 140 in which the received content-related information is stored, a display 110 that reproduces the content image and displays the content identification information to be overlaid on the content image, a sensing device 150 that senses the displayed content identification information, and a controller 120 that controls the operation of the display apparatus 100.

The content management apparatus 200 may be an apparatus that manages contents to be reproduced on the display apparatus 100. The content management apparatus 200 may be an administrator computer or a server connected to the display apparatus 100 at a remote site via a wireless communication network, or may be an apparatus including both the administrator computer and a server.

Here, a content management system 1 according to the embodiment may include the display apparatus 100 and the content management apparatus 200.

When the content management apparatus 200 transmits content-related information to the communication interface 130 of the display apparatus 100, the storage 140 may store the received content-related information therein. The content image reproduced on a single display apparatus 100 for a predetermined time period may include a plurality of content images, and the storage 140 may store a plurality of contents (e.g., a plurality of images or videos) to match pieces of related information, respectively.

The content-related information may include a content image to be reproduced, a time schedule indicating information about a time when the content image is reproduced, content identification information for identifying the content image, and the like. Here, the content image may be an advertisement image provided by an advertiser, and the advertisement image may be a moving image (e.g., animated graphics, video, etc.), or a still image.

The controller 120 may control the display 110 according to the time schedule stored in the storage 140 to reproduce the content image. At this time, the controller 120 may control the display 110 to display the content identification information for identifying the content to be overlaid in a predetermined region of the content image being reproduced.

The sensing device 150 may sense (e.g., detect, determine, identify, etc.) the content identification information displayed on the content image. To this end, the sensing device 150 may be provided at a position corresponding to the region in which the content identification information is displayed.

The controller 120 may generate reproduction confirmation data for verifying whether a predetermined content image has been correctly reproduced at a predetermined time based on a sensing result of the sensing device 150, that is, an output of the sensing device 150.

The reproduction confirmation data generated by the controller 120 may be transmitted to the content management apparatus 200 through the communication interface 130. The advertiser may view the reproduction confirmation data through the content management apparatus 200 or some other device connected to the content management apparatus 200, and verify whether the content requested by the advertiser has been correctly reproduced at a predetermined time.

In addition to the above-described operations, the controller 120 may perform the overall control related to the operation of the display apparatus 100. Accordingly, it should be understood that operations performed by the respective components of the display apparatus 100 may be performed according to the control of the controller 120, without additional descriptions thereof.

The controller 120 may include a memory configured to store programs including instructions for performing the above-described operations and operations to be described later and various types of data related to the operations. The controller 120 may also include a processor (e.g., central processing unit (CPU), an application processor (AP), etc.) that loads commands or data received from the memory and executes the stored programs. The controller 120 may include a single memory and a single processor, or may include a plurality of memories and a plurality of processors. In addition, the memory and the processor may be integrated into a single chip or physically separated from each other.

The communication interface 130 may be a transceiver that includes a wireless communication module that enables communication with an external device through a wireless communication network. The wireless communication module may include at least one from among various wireless communication modules that may be connected to a wide area network (WAN) such as the Internet through a wireless communication method, such as a Global System for Mobile Communication (GSM), a Code Division Multiple Access (CDMA), a Wideband Code Division Multiple Access (WCDMA), a Universal Mobile Telecommunications System (UMTS), Time Division Multiple Access (TDMA), Long Term Evolution (LTE), 4th generation mobile communication (4G), and 5th generation mobile communication (5G), as well as Wi-Fi, and Wireless broadband.

The communication interface 130 may include a receiver that receives content-related information from the content management apparatus 200 and a transmitter that transmits output of the sensing device 150 or reproduction confirmation data to the content management apparatus 200.

The storage 140 may include a non-volatile memory that does not lose the stored programs or data even when the power is interrupted. For example, the storage 140 may include a large capacity flash memory or a solid-state drive (SSD). The non-volatile memory may be configured to store content-related information and a program for controlling the display apparatus 100.

In addition, the storage 140 may further include a volatile memory that temporarily stores data. The volatile memory may store data that is temporarily required to process or compute data.

Hereinafter, the content identification information will be described in detail together with the content management apparatus according to the embodiment.

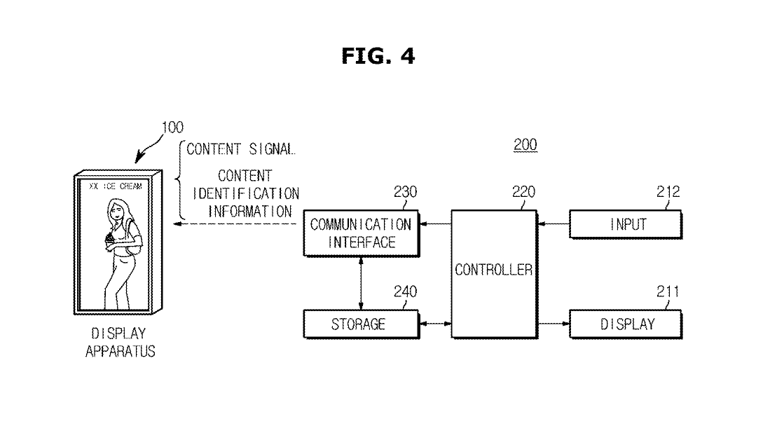

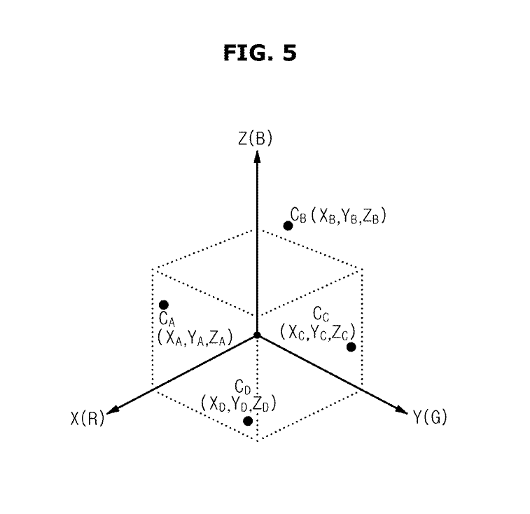

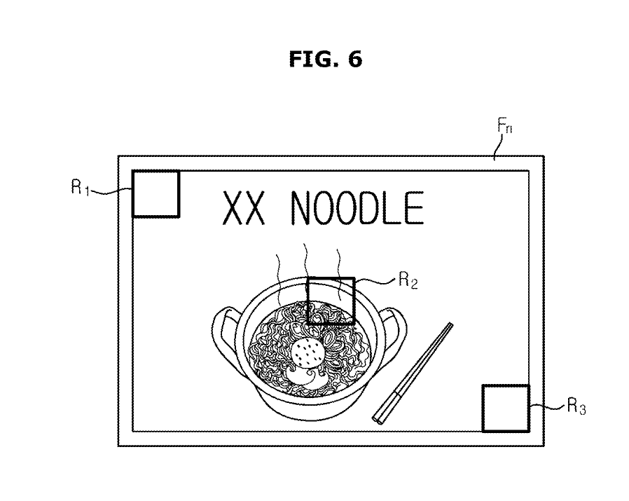

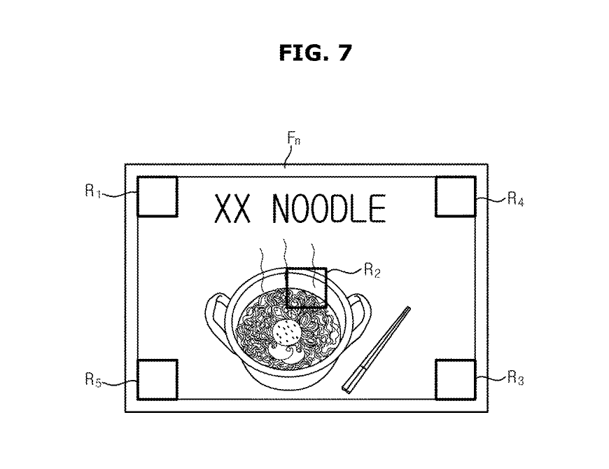

FIG. 4 is a control block diagram illustrating a content management apparatus according to an embodiment. FIG. 5 is a diagram illustrating an example of unique colors assigned by contents, and FIGS. 6 and 7 are diagrams illustrating examples of extracting information from a content image to generate content identification information.

Referring to FIG. 4, the content management apparatus 200 according to the embodiment may include a controller 220 that generates content identification information using a unique color assigned to each content and a corresponding content image, a communication interface 230 that transmits the content image together with the content identification information to the display apparatus 100, a storage 240 configured to temporarily or non-temporarily (e.g., permanently) store the content image and the content identification information, an input 212 that provides a user interface, and a display 211.

As described above, the content management apparatus 200 may include an administrator computer, which may be referred to as a console, a workstation, or a host device, enabling an administrator to manage contents to be reproduced on the display apparatus 100; a server; or both an administrator computer and a server.

The content management apparatus 200 may manage a plurality of display apparatuses 100, and transmit to each display apparatus 100 information about a content image to be reproduced and a time at which the content image is to be reproduced, and receive content reproduction confirmation data from the display apparatus 100.

The controller 220 may set or assign a unique color for each content. The controller 220 may set a unique color to be automatically assigned to each content or may set a unique color for each content according to a user's selection input through the input 212.

Even for the contents provided by the same advertiser, the individual contents may be assigned different and unique colors, and even for the contents corresponding to the same product being advertised, the individual contents may be assigned different unique colors (e.g., according to different time slots). In other words, a unique color may be assigned to each content.

For example, the controller 220 may assign a unique color to each content using an RGB color space, a cyan, magenta, yellow, black (CMYK) color space, a hue, saturation, value (HSV) color space, an International Commission on Illumination (CIE) XYZ color space, and the like.

The unique color may be represented by a color value, and may be represented by a hexadecimal number including color coordinates or coordinate information in a specific color space.

For example, when the red, green, blue (RGB) color space is used, a single color may be represented by a point in a three-dimensional Cartesian coordinate system having three primary colors as reference lines, as shown in FIG. 5. For example, black may be represented by coordinates (0, 0, 0).

The controller 220 may assign a color represented by coordinates C_{A} (x_{A}, y_{A}, z_{A}) to a content A as a unique color, a color represented by coordinates C_{B} (x_{B}, y_{B}, z_{B}) to a content B as a unique color, a color represented by coordinates C_{C} (x_{C}, y_{C}, z_{C}) to a content C as a unique color, a color represented by coordinates C_{D} (x_{D}, y_{D}, z_{D}) to a content D as a unique color, and so forth.

The controller 220 may generate content identification information using the content image and the unique color assigned to the content image. Here, the content identification information may be a content identification color calculated using a pixel value of the content image and a color value of a unique color assigned to the content image. Here, the color value refers to a value capable of representing a corresponding color, such as a hexadecimal number including coordinate values or coordinate value information of the corresponding color.

For example, the controller 220 may use pixel values extracted from a certain region of the content image. As shown in FIGS. 6 and 7, the controller 220 may extract pixel values from predetermined three regions R₁, R₂, and R₃ or five regions R₁, R₂, R₃, R₄, and R₅ from an image frame Fₙ constituting the content. The pixel values may also be represented by color values in the color space.

At least one pixel may be included in each region. When two or more pixels are included in a single region, a representative pixel value of the corresponding region may be calculated through a combination of a sum and/or an average of the pixel values.

In addition, the controller 220 may calculate a representative pixel value of the corresponding image frame Fₙ through a combination of an average and/or a sum the representative pixel values of the respective regions.

The controller 220 may generate a content identification color by combining the representative pixel value of the image frame Fₙ with the color value of the unique color. The combination of the representative pixel value and the unique color value may be achieved using various methods, such as summing, averaging, and the like.

When the content image is a moving image (e.g., video, animated graphics, etc.), the content image may include a plurality of image frames. The controller 220 may generate content identification colors (also referred to as “frame content identification colors” herein) by calculating representative pixel values for the respective frames and combining the representative pixel values with the unique color value, or may generate content identification colors for some frames at predetermined time intervals.

The controller 220 may generate identification color information in the form of a table in which a color value of the generated content identification color matches a corresponding frame.

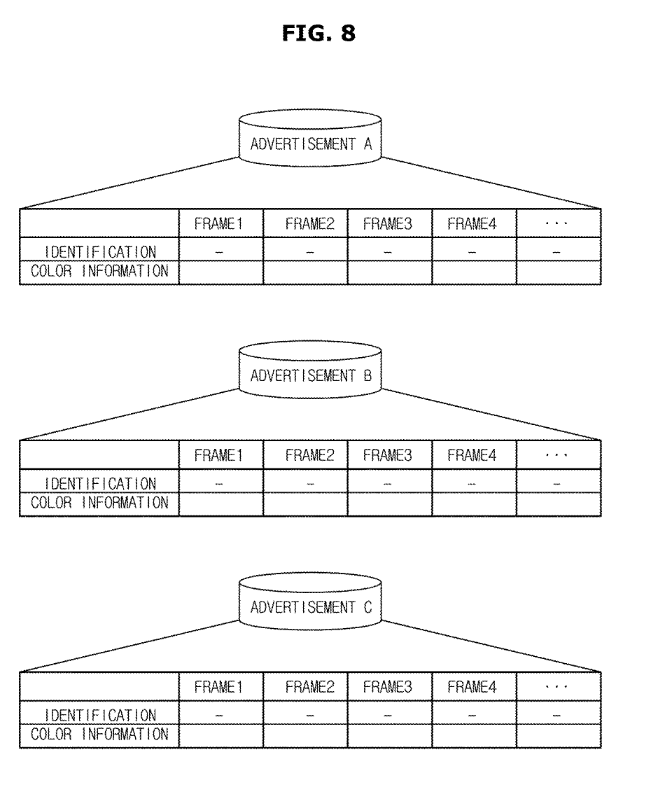

FIG. 8 is a diagram illustrating an example of information generated by the content management apparatus according to an embodiment.

Referring to FIG. 8 illustrating a case that a content identification color is generated for each frame, the controller 220 may generate a content identification color for each frame constituting a content image of an advertisement A, generate a content identification color for each frame constituting a content image of an advertisement B, and generate a content identification color for each frame constituting a content image of an advertisement C.

The storage 240 of the content management apparatus 200 may store content-related information regarding each advertisement in the form of a database.

When a plurality of display apparatuses 100 are managed by the content management apparatus 200, the storage 240 may store information regarding which one of display apparatuses 100 will produce a corresponding content image. Also, a single content image may be reproduced on the plurality of display apparatus 100.

Accordingly, the storage 240 may store information about a display apparatus 100 to be used for reproduction, a time schedule, and a content identification color according to contents in the form of a database, or may store information about a content signal to be reproduced, a time schedule, and a content identification color according to the display apparatus 100 in the form of a database. The information about the content identification color may include identification color information of a corresponding content.

The communication interface 230 may transmit to the display apparatus 100 content-related information of an advertisement to be reproduced. As described above, the content-related information may include a content image, a time schedule, content identification information (identification color information), and the like.

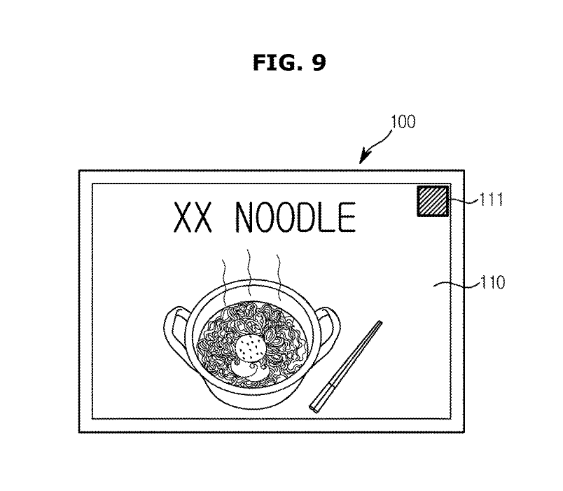

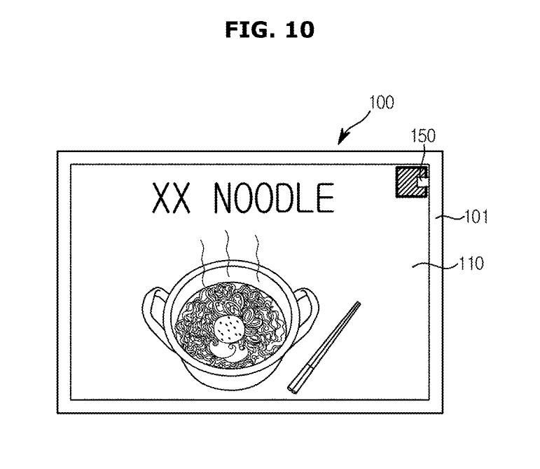

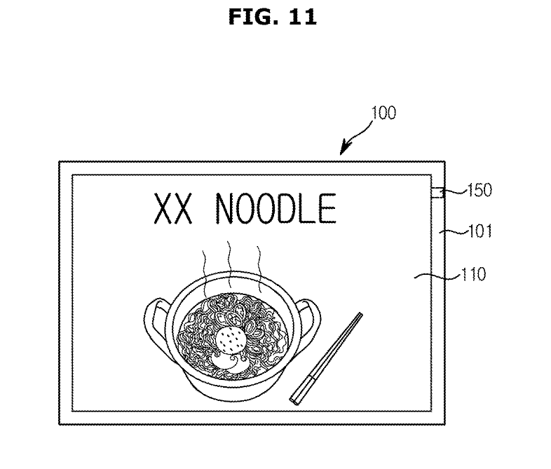

FIG. 9 is a diagram illustrating an example in which a display apparatus according to an embodiment displays a content identification color. FIGS. 10 and 11 are views illustrating an example of a sensing device provided in a display apparatus according to an embodiment.

Referring to FIG. 9, when displaying a received content image on the display 110, the display apparatus 100 according to an embodiment may display an identification color mark 111, which indicates a content identification color of the corresponding content, to be overlaid on a region of the content image.

The identification color mark 111 may represent the content identification color itself. The identification color mark 111 may be provided in a specific shape or pattern having the content identification color. Alternatively, the identification color mark 111 may include a number, a pattern, a code, and the like, indicating the color value of the content identification color.

The display 110 may display the identification color mark 111 for the corresponding frame every frame or at predetermined frame or time intervals. For example, when the content image has a frame rate of 60 Hz, the display 110 may display the identification color mark 111 every frame or only one in ten frames, while displaying sixty frames per second.

Referring to FIG. 10, the sensing device 150 may be provided at a position corresponding to a region where the identification color mark 111 is displayed, to sense the identification color mark 111.

For example, the sensing device 150 may be implemented using an optical sensor, and in particular, using a color sensor, an image sensor, and the like, capable of recognizing colors. When the color sensor is used, the display apparatus 100 may be implemented at a low cost.

The sensing device 150 may be implemented as various types of devices as long as it can recognize colors, and there is no restriction on the type of the sensing device 150 included in the display apparatus 100.

The sensing device 150 may be mounted on at least one side of the display 110. For example, the sensing device 150 may be mounted on the edge of the display 110.

As shown in FIG. 10, the sensing device 150 may be provided on a housing 101 that supports the display 110. The sensing device 150 may be provided at any position, including a location physically separated from the display apparatus 100, as long as it can sense the identification color mark displayed in a predetermined region, and there is no restriction on the position of the sensing device.

For example, the sensing device 150 may be at a predetermined position such that the sensing device 150 projecting or protruding from the housing 101 faces the region in which the identification color mark 111 is displayed. The sensing device 150 may always remain projecting from the housing 101, but according to another embodiment, the sensing device 150 may be retractable inward towards the housing 101 as shown in FIG. 11. In this case, the controller 120 may control the sensing device 150 to project (e.g., protrude, fold out, telescope out, slide out, etc.) so as to overlap with at least a part of the display 110 when a need for sensing the identification color mark 111 arises, and to be retracted otherwise. Alternatively, the projection/retraction of the sensing device 150 may be manually operated.

When the sensing device 150 senses the identification color mark and transmits a result of the sensing to the controller 120, the controller 120 may generate reproduction confirmation data based on the result of the sensing.

As described above, the time schedule and the identification color information transmitted from the content management apparatus 200 may be stored in the storage 140. The controller 120 may compare the sensing result of the sensing device 150 with the stored time schedule and identification color information to determine whether the identification color mark displayed on the display 110 matches the previously stored identification color information.

The controller 120 may retrieve identification color information corresponding to a sensing time of the sensing device 150 among the pieces of identification color information for the respective contents stored in the storage 140. For example, when the sensing time duration of the sensing device 150 is 2:00 PM-2:03 PM, the controller 120 may retrieve identification color information for content that corresponds to the sensing time duration (2:00 PM-2:03 PM) by referring to the stored time schedule. When the content to be reproduced at the corresponding time duration (2:00 PM-2:03 PM) is the advertisement A, the controller 120 may retrieve identification color information for the advertisement A that is stored in the storage 140.

When the sensing device 150 outputs a color value as a sensing result, the controller 120 may compare the output color value with the previously stored identification color information. The identification color information may include a color value of the content identification color generated for each frame as described above with reference to FIG. 8.

The controller 120 may compare the color value output by the sensing device 150 with the color value of the previously stored content identification color to determine a state of being matched/unmatched. The determination may be performed every frame or at a predetermined interval of frames.

The controller 120 may transmit the reproduction confirmation data indicating a state of being matched or unmatched for each frame to the content management apparatus 200 through the communication interface 130. Alternatively, the controller 120 may determine whether the content has been reproduced based on the result of comparing the output of the sensing device 150 with the stored identification color information. For example, the controller 120 may determine that the corresponding content has been reproduced when results of comparisons in all frames are found to be matched. Alternatively, the controller 120 may determine that the corresponding content has been reproduced when results of comparisons in some frames having a value greater than or equal to a predetermined reference value are found to be matched.

Accordingly, the reproduction confirmation data may include a result of comparing a color value, which is an output of the sensing device 150, with a previously stored color value, or a result of determining whether a content has been reproduced.

The controller 120 may transmit the reproduction confirmation data to the content management apparatus 200 through the communication interface 130. The advertiser may request a permission to view the reproduction confirmation data to the content management apparatus 200. Alternatively, when a direct communication between a terminal of the advertiser and the display apparatus 100 is established, the display apparatus 100 may transmit the reproduction confirmation data directly to the terminal of the advertiser.

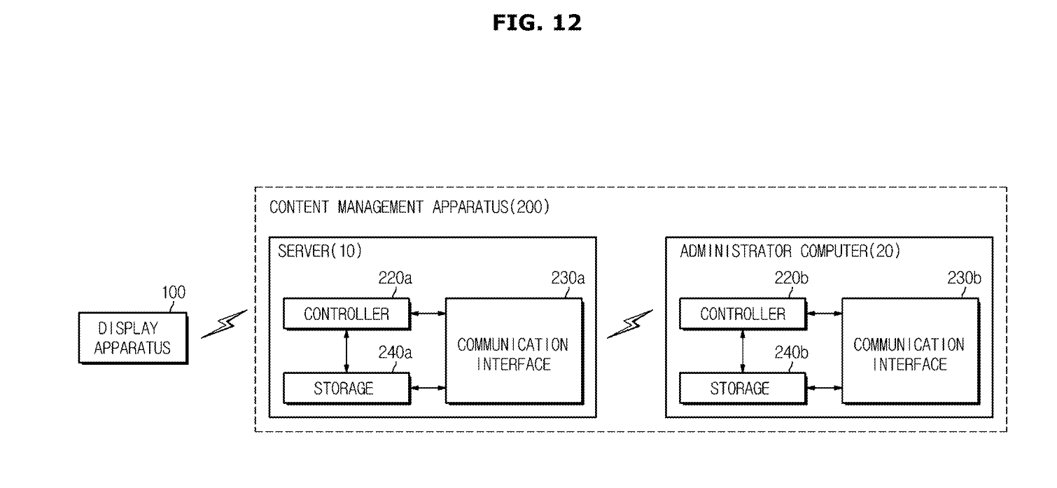

FIG. 12 is a control block diagram illustrating a case in which a content management apparatus includes a server and an administrator computer.

When the content management apparatus 200 includes the server 10 and the administrator computer 20, the controller 220, the communication interface 230, and the storage 240 each may be subdivided between the server 10 and the administrator computer 20.

Accordingly, the server 10 may include a controller 220a that controls the server 10, a communication interface 230a that performs communication between the server 10 and the administrator computer 20 or communication between the server 10 and the display apparatus 100, and a storage 240a that stores information received from the administrator computer 20 or the display apparatus 100 or information processed by the controller 220a.

In addition, the administrator computer 20 may include a controller 220b that controls the administrator computer 20, a communication interface 230b that performs communication between the server 10 and the administrator computer 20 or communication between the administrator computer 20 and the display apparatus 100, and a storage 240b that stores information received from the server 10 or the display apparatus 100, information processed by the controller 220b, or information input from the outside.

The above-described operation of the controller 220 may be performed by at least one from among the controller 220a of the server 10 and the controller 220b of the administrator computer 20, the above-described operations of the communication interface 230 may be performed by at least one from among the communication interface 230a of the server 10 and the communication interface 230b of the administrator computer 20, and the above-described operations of the storage 240 may be performed by at least one from among the storage 240a of the server 10 and the storage 240b of the administrator computer 20.

Hereinafter, examples of exchanging information between the display apparatus 100, the server 10, the administrator computer 20, and the advertiser terminal 30 will be described.

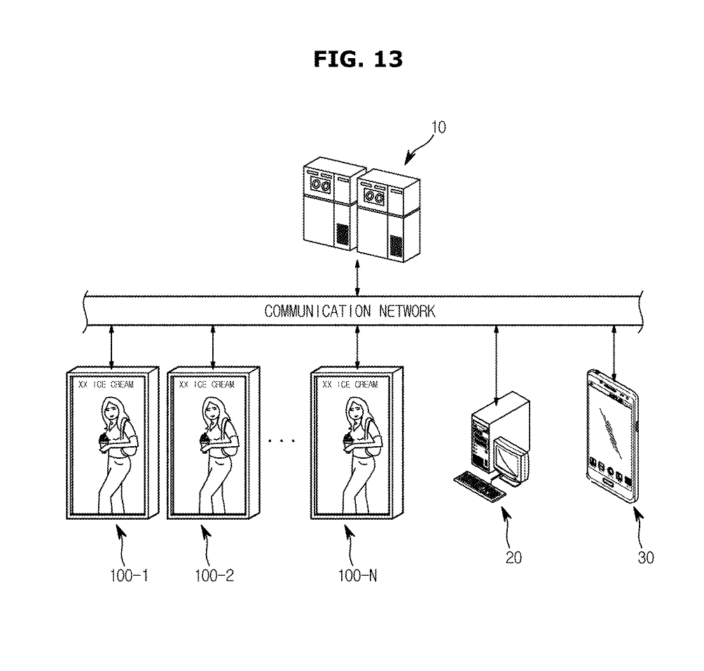

FIG. 13 is a view illustrating an example in which a display apparatus and a content management apparatus according to an embodiment are connected to each other via communication.

Referring to FIG. 13, a single content management apparatus 200 may manage N display apparatuses 100, where N is an integer greater than or equal to 1. A plurality of content images may be reproduced on a single display apparatus 100, and/or a single content image may be reproduced on a plurality of display apparatuses 100. Each of the display apparatuses 100 reproduces a specific content image at a specific time according to a time schedule transmitted from the content management apparatus 200.

The server 10, the administrator computer 20, and the plurality of display apparatuses 100-1, 100-2, . . . , and 100-N may be connected to each other via a wired or wireless communication network.

A user terminal 30 used by the advertiser may also be connected to the server 10 or the administrator computer 20 via the wireless communication network or may be directly connected to at least one from among the plurality of display apparatuses 100-1, 100-2, . . . , and 100-N.

The user terminal 30 may be a wireless terminal used by a user, such as a smartphone, a personal digital assistant (PDA), a personal computer (PC), or a laptop PC, equipped with an application provided by the server 10 or the administrator computer 20. Alternatively, the user terminal 30 may be a dedicated terminal provided for connection to the server 10, the administrator computer 20, or the display apparatus 100.

The administrator computer 20 may be configured to, when new information about a content image is input, update the server 10 with the new information. For example, when a new content image is input, the administrator computer 20 may upload content-related information including information about a display apparatus assigned to reproduce the content image, information about the time for reproducing the content image on a respective one of the display apparatuses 100 (e.g., a time schedule), and content identification information for identifying the content image to the server 10. In addition, the administrator computer 20 may notify the server 10 whenever a change to the content-related information occurs.

The server 10 may store content-related information for each of the plurality of display apparatuses 100-1, 100-2, . . . , and 100-N.

In addition, when new content-related information is uploaded or the existing content-related information is updated with a change to the existing content-related information, the server 10 may transmit the uploaded or updated content-related information to the display apparatus 100 that Is assigned to reproduce the corresponding content.

The display apparatus 100 reproduces a specific content image at a specific time according to the content-related information transmitted from the server 10. In addition, the display apparatus 100 may sense an identification color mark displayed on the content image using the sensing device 150, and upload reproduction confirmation data generated based on a result of the sensing to the server 10.

The user terminal 30 may request permission to view the reproduction confirmation data to the administrator computer 20 or the server 10, and may download the reproduction confirmation data.

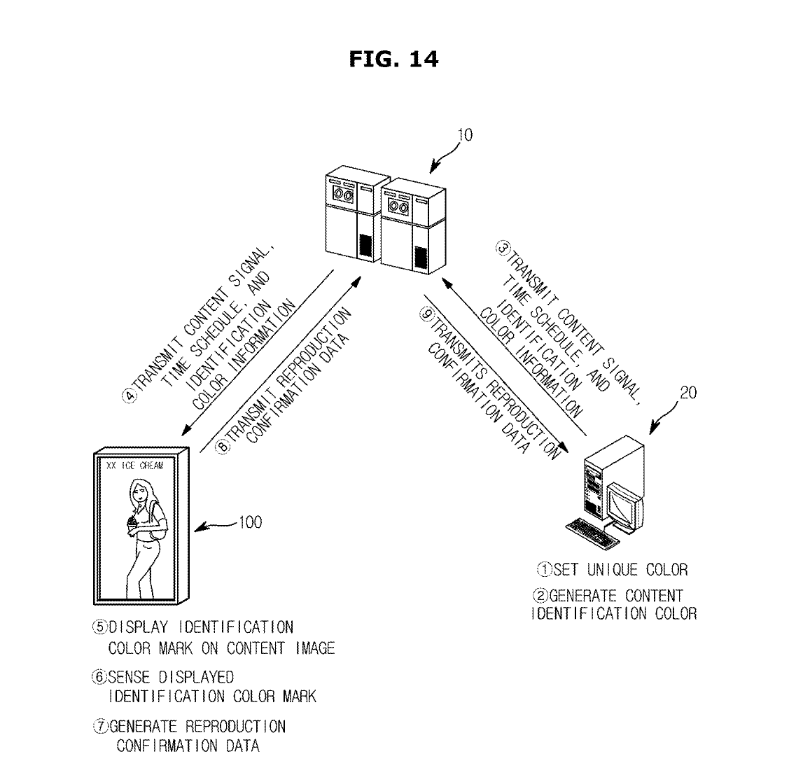

Hereinafter, various examples of processing information and transmitting and receiving information in the administrator computer 20, the server 10, and the display apparatus 100 will be described with reference to FIGS. 14 to 17.

FIG. 14 is a view illustrating an example in which information is processed and transmitted and received in an administrator computer, a server, and a display apparatus.

Referring to FIG. 14, the administrator computer 20 may set a unique color for content (1), and generate a content identification color for identifying the content using the unique color and the content image (2).

The unique color for the content may be automatically assigned by the administrator computer 20, or may be set based on an input of an administrator or a user.

For example, the administrator computer 20 may extract pixel values from predetermined regions of an image frame and calculate a representative pixel value of the image frame. The representative pixel value of the image frame and the unique color value assigned to the corresponding content may be combined (e.g., summed, averaged, etc.) to generate a content identification color.

The administrator computer 20 may generate the content identification color for each frame constituting a content image or may generate the content identification color at a predetermined interval of frames. The administrator computer 20 may allow the generated content identification color to match a frame corresponding thereto, to generate identification color information in the form of a table.

The administrator computer 20 may transmit a content signal, a time schedule, and identification color information to the server 10 (3). The time schedule may include information about a time at which the content image is reproduced and a display apparatus on which the content image is reproduced.

The server 10 may transmit the content signal, the time schedule, and the identification color information to the display apparatus 100 based on the information included in the received time schedule (4). In addition, the server 10 may store information about the display apparatuses 100 to be used for reproduction, time schedules, and identification color information according to the contents in the form of a database, or may store content signals to be reproduced, time schedules, and identification color Information according to the display apparatuses 100 in the form of a database.

The display apparatus 100 may reproduce (e.g., display) the content image according to the transmitted time schedule. At this time, the display apparatus 100 may display an identification color mark 111 to be overlaid on the content image (5). The identification color mark 111 may represent the content identification color itself or may represent the color value of the content identification color.

The sensing device 150 provided on the display apparatus 100 may sense the displayed identification color mark (6). For example, the sensing device 150 may output a color value as a sensing result.

The controller 120 of the display apparatus 100 may generate reproduction confirmation data based on the sensing result of the sensing device 150 (7). The reproduction confirmation data may include a result of comparing a color value, which is an output of the sensing device 150, with a color value of previously stored identification color information, or a result of determining whether the content has been reproduced. For example, the controller 120 may determine that the corresponding content has been reproduced when results of comparisons in all frames are found to be matched. Alternatively, the controller 120 may determine that the corresponding content has been reproduced when results of comparisons in some frames having a value greater than or equal to a predetermined reference value are found to be matched.

The display apparatus 100 may transmit the reproduction confirmation data to the server 10 through the communication interface 130 (8).

The server 10 may store the reproduction confirmation data, and transmit the reproduction confirmation data to the administrator computer 20 (9) in response to receiving a viewing request from the administrator computer 20. Alternatively, the server 10 may transmit the reproduction confirmation data regardless of a request from the administrator computer 20, or may transmit the reproduction confirmation data directly to the user terminal 30.

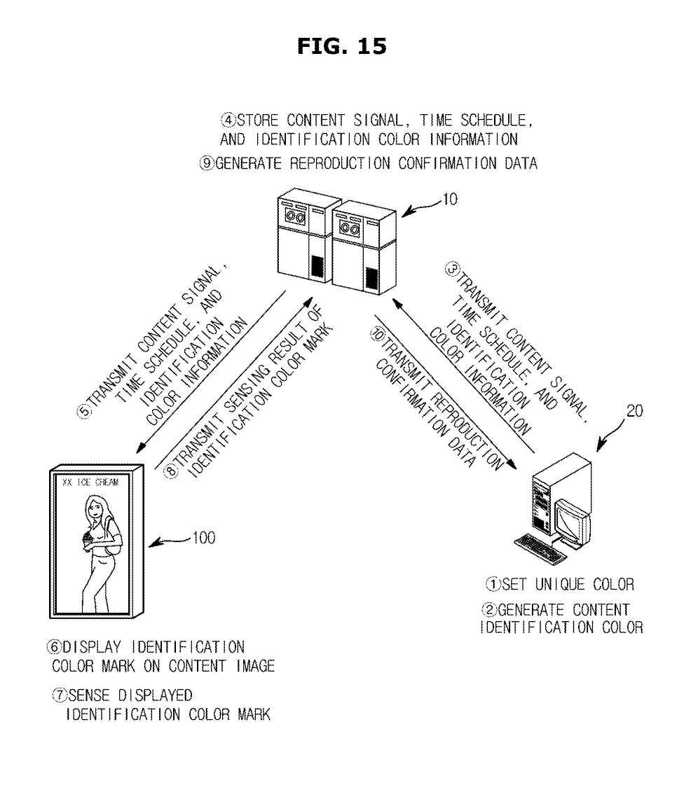

FIG. 15 is a view illustrating another example in which information is processed and transmitted and received in an administrator computer, a server, and a display apparatus.

As compared to FIG. 14 in which the display apparatus 100 senses the identification color mark and generates the reproduction confirmation data, FIG. 15 illustrates an example in which the server 10 generates the reproduction confirmation data.

Referring to FIG. 15, the administrator computer 20 may set (e.g., assign) a unique color for content (1), generate a content identification color (2), and transmit a content signal, a time schedule, and identification color information to the server 10 (3) in the same manner as described with reference to FIG. 14.

The server 10 may store the received content signal, time schedule, and identification color information (4). In the same manner as described above, the server 10 may store information about the display apparatuses 100 to be used for reproduction, time schedules, and identification color information according to contents in the form of a database, or may store content signals to be reproduced, time schedules, and identification color Information according to the display apparatuses 100 in the form of a database.

The server 10 may transmit the content signal, the time schedule, and the identification color information to the display apparatus 100 based on information included in the received time schedule (5).

The display apparatus 100 may reproduce (e.g., display) the content image according to the received time schedule. At this time, the display apparatus 100 may display an identification color mark 111 to be overlaid on the content image (6).

The sensing device 150 provided on the display apparatus 100 may sense the displayed identification color mark (7). For example, the sensing device 150 may output a color value as a sensing result.

According to the example, the display apparatus 100 may transmit the sensing result output in the form of a color value to the server 10 (8). The server 10 may generate reproduction confirmation data based on the sensing result (9). The reproduction confirmation data may include a result of comparing a color value, which is an output of the sensing device 150, with a color value of previously stored identification color information, or a result of determining whether the content has been reproduced.

The server 10 may store the reproduction confirmation data, and transmit the reproduction confirmation data to the administrator computer 20 (10) in response to receiving a viewing request from the administrator computer 20. Alternatively, the server 10 may transmit the reproduction confirmation data regardless of a request from the administrator computer 20, or may transmit the reproduction confirmation data directly to the user terminal 30.

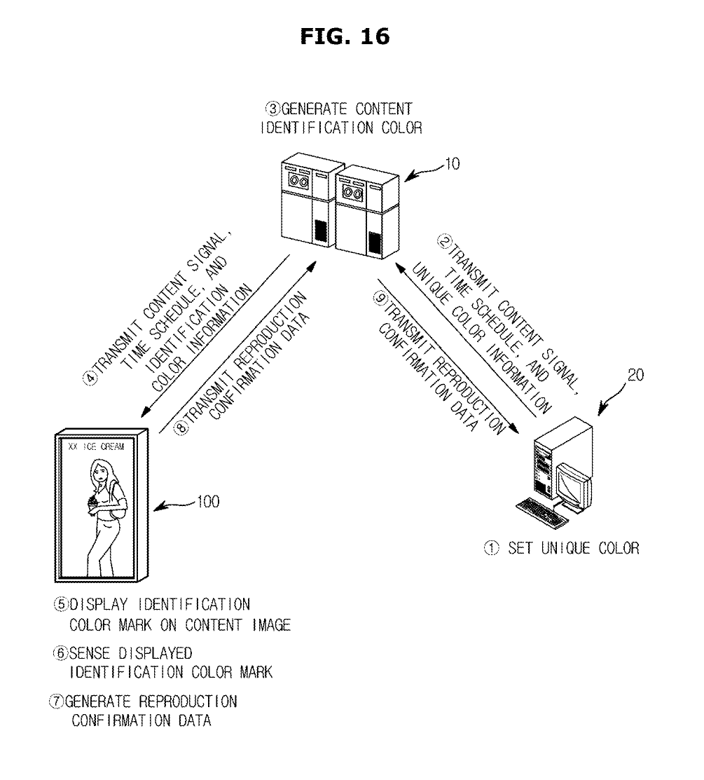

FIG. 16 is a view illustrating another example in which information is processed and transmitted and received in an administrator computer, a server, and a display apparatus.

As compared to FIGS. 14 and 15, in which the administrator computer 20 generates the content identification color, FIG. 16 illustrates an example in which the server 10 generates the content identification color.

Referring to FIG. 16, the administrator computer 20 may set (e.g., assign) a unique color for content (1) in the same manner as described in the preceding examples.

The administrator computer 20 may transmit a content signal, a time schedule, and unique color information set for the corresponding content to the server 10 (2).

The server 10 may generate the content identification color using the unique color and the content image (3). For example, the server 10 may extract pixel values from predetermined regions of an image frame constituting a content image, and calculate a representative pixel value of the image frame. The representative pixel value of the image frame and the unique color value assigned to the corresponding content may be combined to generate a content identification color. The server 10 may allow the generated content identification color to match a frame corresponding thereto, thereby generating identification color information in the form of a table.

In addition, the server 10 may store information about display apparatuses 100 assigned for reproduction, time schedules, and identification color information according to contents in the form of a database, or may store content signals to be reproduced, time schedules, and identification color information according to display apparatuses 100 in the form of a database.

The server 10 may transmit the content signal, time schedule, the time schedule, and the identification color information to the display apparatus 100 based on information included in the received time schedule (4).

The display apparatus 100 may reproduce the content image according to the transmitted time schedule. At this time, the display apparatus 100 may display an identification color mark 111 to be overlaid on the content image (5). The identification color mark 111 may represent the content identification color itself or may represent the color value of the content identification color.

The sensing device 150 provided on the display apparatus 100 senses the displayed identification color mark (6). For example, the sensing device 150 may output a color value as a sensing result.

The controller 120 of the display apparatus 100 may generate reproduction confirmation data based on the sensing result of the sensing device 150 (7). The reproduction confirmation data may include a result of comparing a color value, which is an output of the sensing device 150, with a color value of previously stored identification color information, or a result of determining whether the content has been reproduced. The controller 120 may determine that the corresponding content has been reproduced when results of comparisons in all frames are found to be matched. Alternatively, the controller 120 may determine that the corresponding content has been reproduced when results of comparison in all frames are found to be matched. Alternatively, the controller 120 may determine that the corresponding content has been reproduced when results of comparisons in some frames having a value greater than or equal to a predetermined reference value are found to be matched. The display apparatus 100 may transmit the reproduction confirmation data to the server 10 through the communication interface 130 (8).

The server 10 may store the reproduction confirmation data, and transmit the reproduction confirmation data to the administrator computer 20 (9) in response to receiving a viewing request from the administrator computer 20. Alternatively, the server 10 may transmit the reproduction confirmation data regardless of a request from the administrator computer 20, or may transmit the reproduction confirmation data directly to the user terminal 30.

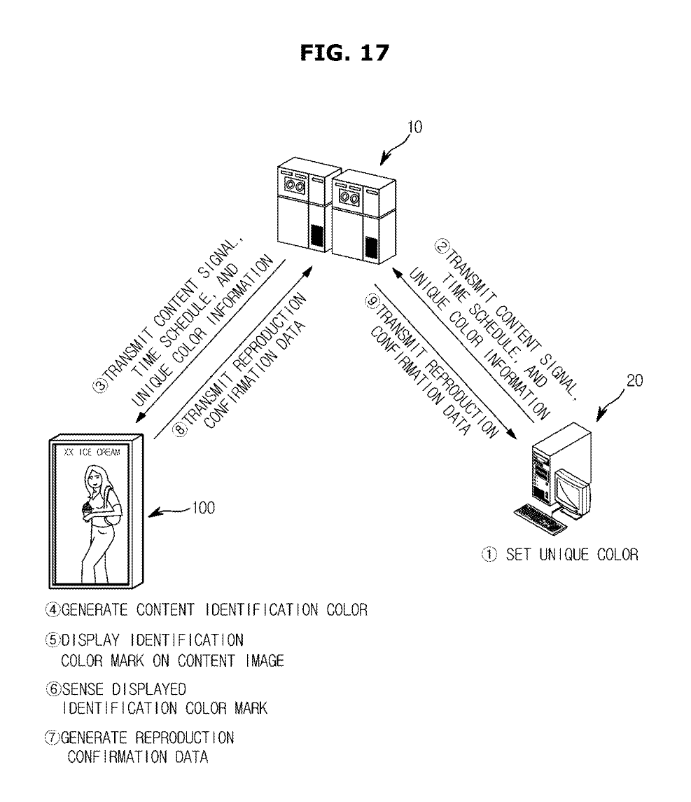

FIG. 17 is a view illustrating another example in which information is processed and transmitted and received in an administrator computer, a server, and a display apparatus.

As compared to FIGS. 14 to 16 in which the identification color is generated by the administrator computer 20 or the server 10, FIG. 17 illustrates an example in which the identification color is generated by the display apparatus 100.

Referring to FIG. 17, the administrator computer 20 may set (e.g., assign) a unique color for content (1). Description of setting the unique color is identical to those described in the preceding examples.

The administrator computer 20 may transmit a content signal, a time schedule, and unique color information set for the corresponding content to the server 10 (2).

The server 10 may transmit the content signal, the time schedule, and the unique color information to the display apparatus 100 based on information included in the received time schedule (3). In addition, the server 10 may store information about the display apparatuses 100 to be used for reproduction, time schedules, and pieces of unique color information according to contents in the form of a database, or may store content signals to be reproduced, time schedules, and pieces of unique color Information according to the display apparatuses 100 in the form of a database.

The controller 120 of the display apparatus 100 may generate a content identification color using the unique color and the content image (4). For example, the controller 120 may extract pixel values from predetermined regions of an image frame and calculate a representative pixel value of the image frame. The representative pixel value of the image frame and the unique color value assigned to the corresponding content may be combined to generate a content identification color.

The display apparatus 100 may reproduce (e.g., display) the content image according to the transmitted time schedule. At this time, the display apparatus 100 may display an identification color mark 111 to be overlaid on the content image (5). The identification color mark 111 may represent the content identification color itself or may represent the color value of the content identification color.

The sensing device 150 provided on the display apparatus 100 may sense the displayed identification color mark (6). For example, the sensing device 150 may output a color value as a sensing result.

The controller 120 of the display apparatus 100 may generate reproduction confirmation data based on the sensing result of the sensing device 150 (7). The reproduction confirmation data may include a result of comparing a color value, which is an output of the sensing device 150, with a color value of previously stored identification color information, or a result of determining whether the content has been reproduced. The controller 120 may determine that the corresponding content has been reproduced when results of comparisons in all frames are found to be matched. Alternatively, the controller 120 may determine that the corresponding content has been reproduced when results of comparisons in some frames having a value greater than or equal to a predetermined reference value are found to be matched. The display apparatus 100 may transmit the reproduction confirmation data to the server 10 through the communication interface 130 (8).

The server 10 may store the reproduction confirmation data, and transmit the reproduction confirmation data to the administrator computer 20 (9) in response to sensing a viewing request from the administrator computer 20. Alternatively, the server 10 may transmit the reproduction confirmation data regardless of a request from the administrator computer 20, or may transmit the reproduction confirmation data directly to the user terminal 30.

Even when a specific content has been actually reproduced on a specific display apparatus 100 at a specific time, the reproduction confirmation data may indicate that the content has not been reproduced. In this case, it is determined that an error has occurred in the display 110, and a corresponding measure may be taken. Occurrence of the error in the display 110 may be directly determined by the administrator based on the reproduction confirmation data and reproduction records of the display apparatus 100, or may be determined by the controller 220 of the content management apparatus 200. In the latter case, the controller 220 may output an error notification message through a user interface of the content management apparatus 200.

Hereinafter, an embodiment of a content management method according to one aspect will be described.

In order to perform the content management method according to the aspect, the display apparatus 100 or the content management apparatus 200 according to the above-described embodiments may be used. Therefore, the descriptions of the display apparatus 100 and the content management apparatus 200 described above with reference to FIGS. 1 to 17 may be applied to the embodiment of the content management method.

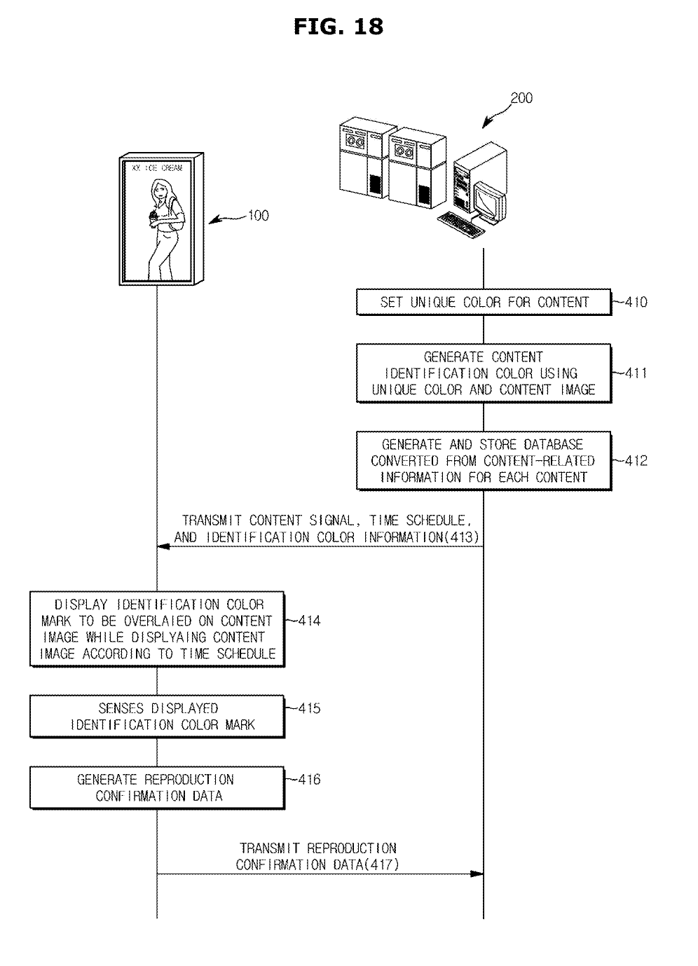

FIG. 18 is a flowchart showing an example of a content management method according to an embodiment.

Referring to FIG. 18, the content management apparatus 200 may set (e.g., assign) a unique color for content (410). For example, the controller 220 of the content management apparatus 200 may automatically assign a unique color to each content using the RGB color space, the CMYK color space, the HSV color space, the CIE XYZ color space, or the like. Alternatively, the controller 220 may set a unique color based on a user's input.

The content management apparatus 200 may generate a content identification color using a unique color and a content image (411). For example, the controller 220 may use pixel values extracted from predetermined regions of the content image. A representative pixel value of the content image may be calculated using the extracted pixel values, and the representative pixel value may be combined with the unique color to generate a content identification color.

When the content image is a moving image, the content image may include a plurality of image frames. The controller 220 may generate content identification colors by calculating representative pixel values for the respective frames and combining the representative pixel values with the unique color value, or may generate content identification colors for some frames at predetermined intervals.

The controller 220 may generate identification color information in the form of a table in which the generated content identification color matches a frame corresponding thereto.

The content management apparatus 200 may convert content-related information for each content in a database and store the content-related information in the storage 240 (412). The content-related information may include a content image, a time schedule, identification color information, and the like. The storage 240 may store information about display apparatuses 100 assigned for reproduction, time schedules, identification color information, and the like according to contents in the form of a database, or may store content signals, time schedules, and identification color information according to the display apparatuses 100 in the form of a database.

The content management apparatus 200 may transmit the content signal, the time schedule, and the identification color information to the display apparatus 100 (413).

The display apparatus 100 may display an identification color mark to be overlaid on a content image while displaying the content image according to the time schedule (414). The identification color mark 111 may represent the content identification color itself or may represent the color value of the content identification color. The display apparatuses 100 may display the identification color mark 111 for the corresponding frame every frame or at predetermined intervals.

The sensing device 150 of the display apparatus 100 may sense the displayed identification color mark (415). The sensing device 150 may be provided at a position corresponding to a region where the identification color mark 111 is displayed, to sense the identification color mark 111. For example, a sensing result of the sensing device 150 may be output as a color value.

The controller 120 of the display apparatus 100 may generate reproduction confirmation data based on the sensing result (416). For example, the controller 120 may determine whether the identification color mark displayed on the display 110 matches previously stored identification color information by comparing the sensing result of the sensing device 150 with the stored time schedule and the stored identification color information. The controller 120 may determine only a state of being matched/unmatched for each frame, or may further determine whether the content has been reproduced based on the comparison result. The controller 120 may determine that the corresponding content has been reproduced when results of comparisons in all frames are found to be matched, or when results of comparisons in some frames having a value greater than or equal to a predetermined reference value are found to be matched. Accordingly, the reproduction confirmation data may include a result of determination about being matched or unmatched between the previously stored identification color information and the identification color mark color value, or include information indicating whether content has been reproduced.

The display apparatus 100 may transmit the reproduction confirmation data to the content management apparatus 200 (417). The advertiser may request permission to view the reproduction confirmation data to the content management apparatus 200. Alternatively, when a direct communication between a terminal of the advertiser and the display apparatus 100 is established, the display apparatus 100 may transmit the reproduction confirmation data directly to the terminal of the advertiser.***

Although the present example illustrates that the display apparatus 100 generates reproduction confirmation data, the present disclosure is not limited thereto. For example, the display apparatus 100 may transmit the sensing result of the sensing device 150 to the content management apparatus 200, and the content management apparatus 200 may generate reproduction confirmation data based on the received sensing result.

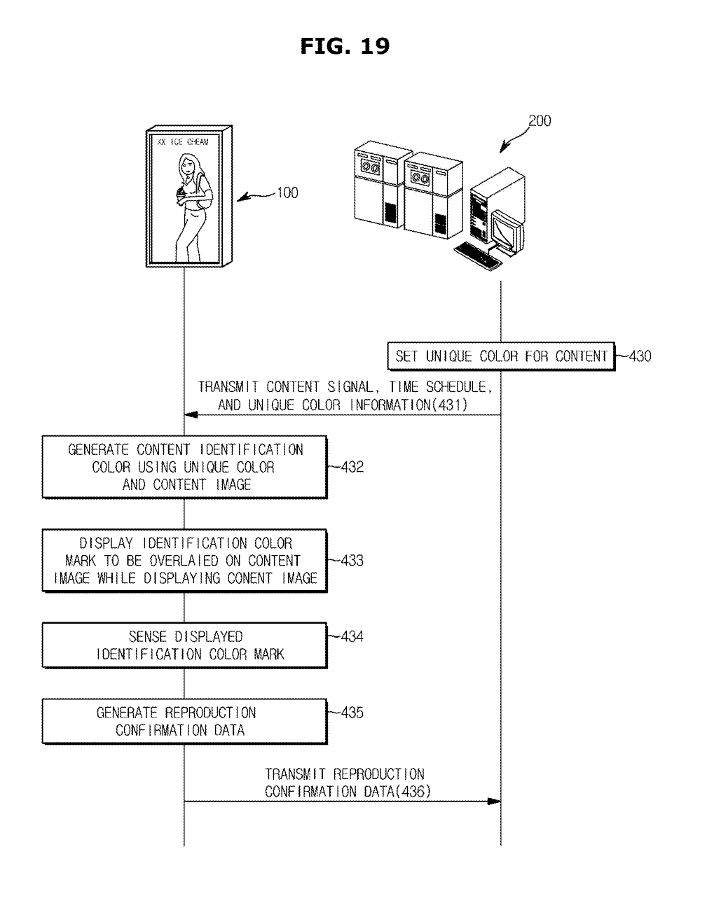

FIG. 19 is a flowchart showing another example of a content management method according to an embodiment.

Referring to FIG. 19, the content management apparatus 200 sets a unique color for content (430). The description of setting the unique color is identical to those described above.

The content management apparatus 200 transmits a content signal, a time schedule, and unique color information for the corresponding content to the display apparatus 100 (431).

The display apparatus 100 generates a content identification color using the unique color and the content image (432). The controller 120 of the display apparatus 100 may calculate a representative pixel value of the content image by using pixel values extracted from predetermined regions of the content image, and generate a content identification color by combining the representative pixel value with the unique color. When the content image is a moving image, the content identification color may be generated for each frame constituting the content image or may be generated at a predetermined interval of frames.

In addition, the controller 120 may generate identification color information in the form of a table by matching the generated content identification color and a frame corresponding thereto.

When displaying a content image according to a time schedule, the display apparatus 100 may display an identification color mark to be overlaid on the content image (433). The identification color mark 111 may represent a content identification color itself, or a color value of a content identification color. The display apparatus 100 may display the identification color mark 111 for the corresponding frame every frame or at predetermined intervals.

The sensing device 150 of the display apparatus 100 senses the displayed identification color mark (434). The sensing device 150 may be provided at a position corresponding to a region where the identification color mark 111 is displayed, to sense the identification color mark 111. For example, a sensing result of the sensing device 150 may be output as a color value.

The controller 120 of the display apparatus 100 generates reproduction confirmation data based on the sensing result (435).

The display apparatus 100 transmits the reproduction confirmation data to the content management apparatus 200 (436). The advertiser may request a permission to view the reproduction confirmation data to the content management apparatus 200. Alternatively, when a direct communication between a terminal of the advertiser and the display apparatus 100 is established, the display apparatus 100 may transmit the reproduction confirmation data directly to the terminal of the advertiser.

Similar to the example described with reference to FIG. 18, the display apparatus 100 may transmit the sensing result of the sensing device 150 to the content management apparatus 200, and the content management apparatus 200 may generate reproduction confirmation data based on the received sensing result.

Embodiments of the content management method do not need to include all the operations shown in FIGS. 18 and 19, but may selectively include some of the operations depending on the entity performing the content management method. For example, when the entity that performs the content management method is the display apparatus, all or some of the operations performed by the display apparatus 100 among the operations shown in FIGS. 18 and 19 may be included in the embodiment of the content management method. Alternatively, when the content management apparatus 200 is the entity that performs the content management method, all or some of the operations performed by the content management apparatus 200 among the operations shown in FIGS. 18 and 19 may be included in the embodiment of the content management method.

The display apparatus, the content management apparatus, the content management system, and the content management method according to the above-described embodiments are provided to verify whether a specific content is reproduced on a specific display apparatus at a specific time by assigning a unique color to each content, and displaying a content identification color generated using the unique color and the content image to be overlaid on the content image

In addition, the display apparatus is provided with the sensing device to sense the content identification color displayed on the content image, so that whether the content is correctly reproduced may be verified at a low cost.

As is apparent from the display apparatus, the content management apparatus, the content management system, and the content management method according to the above-described embodiments, whether specific content is correctly reproduced may be verified by assigning a unique color to each content and displaying a content identification color, which is generated using a content image and the unique color, and overlaid on the corresponding content image.

What is claimed is:

1. A display apparatus comprising:
a receiver configured to receive a content image;
a display configured to reproduce the content image and display, over the content image being reproduced, a content identification color for identifying the content image;
a sensing device provided on at least one side of the display; and
a controller configured to generate reproduction confirmation data for verifying reproduction of the content image based on an output of the sensing device.

2. The display apparatus of claim 1, wherein the sensing device is configured to sense the content identification color displayed over the content image.

3. The display apparatus of claim 1, wherein the controller is further configured to generate the content identification color using a representative pixel value of at least one region of the content image and a unique color assigned to the content image.

4. The display apparatus of claim 1, wherein the receiver is further configured to receive the content identification color generated using a unique color assigned to the content image and the content image.

5. The display apparatus of claim 2, wherein the controller is further configured to generate the reproduction confirmation data by comparing the content identification color with the output of the sensing device.

6. The display apparatus of claim 2, wherein the content identification color includes a plurality of frame content identification colors respectively corresponding to a plurality of image frames included in the content image.

7. The display apparatus of claim 6, wherein the display is further configured to, while displaying one image frame of the plurality of image frames, display, over the one image frame, a frame content identification color corresponding to the one image frame.

8. The display apparatus of claim 6, wherein the controller is further configured to compare the output of the sensing device with the content identification color at each of the plurality of image frames to determine whether the output of the sensing device matches the content identification color, and
wherein the reproduction confirmation data includes a result of the determination whether the output of the sensing device matches the content identification color.

9. The display apparatus of claim 1, further comprising a transmitter configured to transmit the reproduction confirmation data to a content management apparatus.

10. The display apparatus of claim 1, wherein the display is further configured to display the content identification color in a predetermined region of the display, and
wherein the sensing device is provided at a position corresponding to the predetermined region in which the content identification color is displayed.

11. The display apparatus of claim 10, wherein the sensing device is provided at an edge of the display so as to be projected or retracted.

12. The display apparatus of claim 2, wherein the receiver is further configured to receive a time schedule including information about a point of time for reproducing the content image, and
wherein the controller is further configured to compare the content identification color and the time schedule with the output of the sensing device and an output time of the sensing device, respectively, to generate the reproduction confirmation data.

13. A display apparatus comprising:
a communication interface configured to receive a content image;
a display configured to reproduce the content image and display, over the content image being reproduced, a content identification color for identifying the content image;
a sensing device mounted on at least one side of the display; and
a controller configured to control the communication interface to transmit an output of the sensing device to a content management apparatus.

14. The display apparatus of claim 13, wherein the sensing device is configured to sense the content identification color displayed over the content image.

15. The display apparatus of claim 14, wherein the controller is further configured to generate the content identification color using a representative pixel value of at least one region of the content image and a unique color assigned to the content image.

16. The display apparatus of claim 14, wherein the communication interface is further configured to receive the content identification color generated using a unique color assigned to the content image and the content image.

17. The display apparatus of claim 13, wherein the content identification color includes a plurality of frame content identification colors respectively corresponding to a plurality of image frames included in in the content image.

18. The display apparatus of claim 17, wherein the display is further configured to, while displaying one image frame of the plurality of image frames, display, over the one image frame, a frame content identification color corresponding to the one image frame.

19. The display apparatus of claim 13, wherein the sensing device is provided at an edge of the display so as to be projected or retracted.

20. A content management method comprising:
receiving a content image;
reproducing the content image;
while the content image is being reproduced, displaying, over the content image being reproduced, a content identification color for identifying the content image;
sensing the content identification color displayed over the content image using a sensing device mounted on at least one side of the display; and
generating reproduction confirmation data for verifying reproduction of the content image based on a result of sensing the displayed content identification color.
